(19) United States
(12) Patent Application Publication
(10) Pub. No.: US 2021/0239880 A1
(43) Pub. Date: Aug. 5, 2021

(54) Systems, Methods and Apparatus for Measuring Atmospheric Turbulence

(71) Applicant: Government of the United States, as represented by the secrectary of the Air Force, Wright-Patterson AFB, OH (US)

(72) Inventors: Steven M. Zuraski, Beavercreek, OH (US); Elizabeth A. Beecher, Beavercreek, OH (US); Steven T. Fiorino, Beavercreek, OH (US); Jason D. Schmidt, Waynesville, OH (US); Jack E. McCrae, JR., Bellbrook, OH (US); Nathan Figlewski, Valrico, FL (US)

(21) Appl. No.: 16/778,424

(22) Filed: Jan. 31, 2020

(51) Int. Cl. G01W 1/00; G01J 9/00

(52) U.S. Cl. CPC G01W 1/00; G01J 2009/002; G01J 9/00

(57) ABSTRACT

Systems, methods and apparatus to profile atmospheric turbulence. The apparatus includes a telescope having a telescope optical axis and a laser to generate a plurality of pulses at a pulse repetition rate. A laser beam mechanism, coupled to the laser, has a laser optical axis substantially coincident with the telescope optical axis, such that the plurality of pulses forms a collimated laser beam propagating along the telescope optical axis. The apparatus also includes at least one shutter coupled to the telescope and one or more wavefront sensors, coupled to the shutter, which acts as a range gate for the wavefront sensor. A controller is coupled to the laser and the shutter to coordinate operation of the shutter with a pulse of the plurality of pulses.

### STATEMENT OF GOVERNMENT INTEREST

The embodiments described herein may be manufactured and used by or for the Government of the United States for all governmental purposes without the payment of any royalty.

### FIELD OF THE DISCLOSURE

The present disclosure relates to a dynamic range gate atmospheric turbulence profiler. Specifically, the disclosed dynamic range gate atmospheric turbulence profiler utilizes wavefront sensors to provide improved performance compared to conventional approaches.

### BACKGROUND

One conventional method for turbulence profiling was to passively measure and calculate the strength of turbulence via an index of refraction structure constant Cₙ² from video imagery gathered by a video camera. Such conventional methods purported to simplify instrumentation requirements, reduce cost, and provide rapid data output by combining an angle of arrival with a spatial/temporal frequency domain method.

### BRIEF SUMMARY

Embodiments described herein are directed to systems, methods and apparatus to profile atmospheric turbulence. The apparatus includes a telescope having a telescope optical axis and a laser configured to generate a plurality of pulses at a pulse repetition rate. A laser beam mechanism, coupled to the laser, has a laser optical axis configured to be substantially coincident with the telescope optical axis, such that the plurality of pulses forms a collimated laser beam propagating along the telescope optical axis. The apparatus also includes at least one shutter coupled to the telescope and one or more wavefront sensors, coupled to the shutter, which acts as a range gate for the wavefront sensor. A controller is coupled to the laser and the shutter and is configured to coordinate operation of the shutter with a pulse of the plurality of pulses.

### BRIEF DESCRIPTION OF THE DRAWINGS

The accompanying drawings, which are incorporated in and constitute a part of this specification, illustrate embodiments of the present disclosure and, together with a general description given above, and the detailed description given below, serve to explain the principles of the present disclosure.

FIG. 1 shows a telescope according to an embodiment described herein.

FIG. 2 is a representation of a modeled layout of components of a sensing system mounted to an optical breadboard on a backside of a telescope.

FIG. 3 is a representation of an example waveform measured by a wavefront sensor.

FIG. 4 is a representation of a beacon showing initial measurement configuration.

FIG. 5 is a representation of measurement regions for altitudes ranging from the ground to heights H₁ and H₂.

FIG. 6 is a representation of a system according to an embodiment described herein.

FIG. 7 is a graphical representation of sensor variance according to an embodiment described herein.

FIG. 8 shows a representation of a model layout of a system according to an embodiment described herein.

FIG. 9 shows a flowchart according to an embodiment described herein.

FIGS. 10A and 10B show representations of a model of a sensing system for beacon ranges of infinity and 5 km, respectively.

FIGS. 11A and 11B show representations of a model of a sensing system for beacon ranges of 1 km and 0.4 km, respectively.

FIG. 12 is a representation of movement of the image plane relative to the telescope's natural focus for low altitude beacons.

FIG. 13 shows a representation of a curvature experienced between two polarizers.

FIG. 14 shows a representation of a polarization rectifier according to an embodiment described herein.

FIGS. 15A and 15B shows a representation of optical field curvature experience without and with a polarization rectifier, respectively.

It should be understood that the appended drawings are not necessarily to scale, presenting a somewhat simplified representation of various features illustrative of the basic principles of the disclosure. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The present disclosure will now be described more fully hereinafter with reference to the accompanying drawings, in which preferred embodiments are shown. This disclosure may, however, be embodied in many different forms and should not be construed as limited to the embodiments set forth herein. Rather, these embodiments are provided so that this disclosure will be thorough and complete, and will fully convey the scope to those skilled in the art.

This disclosure is directed to a dynamic range gate atmospheric turbulence profiler, which offers an improvement to current techniques for measuring atmospheric turbulence. The ability to produce configurable profiled measurements of current atmospheric turbulence from an active reference source increases performance and applications. This novel approach enhances understanding of layered effects of atmospheric turbulence, which improves models for Intelligence, Surveillance, and Reconnaissance (ISR) and Directed Energy Weapons (DEW) missions. Additionally, the atmospheric profiler described herein may be used as a technique for mitigating undesired atmospheric turbulence effects when coupled with an adaptive optics system.

As described herein, the present disclosure recognizes that the narrow nature of the monochromatic light used is less effected by day operations and/or night operations when appropriate filters are used. The embodiments described herein have improved performance results as ambient conditions worsen and more undesired light scattering is present.

It is an embodiment of the present disclosure to take profile measurements of the refractive index structure parameter (atmospheric turbulence). This is a parameter that quantifies atmospheric seeing and is important to scientific fields such as astronomy, optics, and atmospheric physics. It is also of interest to military fields such as Intelligence, Surveillance, and Reconnaissance (ISR) and Directed Energy Weapons (DEWs).

Measuring the refractive index structure parameter is accomplished with novel engineering system designs that enable rapid profiled measurements all while the atmosphere can be considered relatively frozen in terms of turbulent flow. Conventional approaches (methods, techniques, apparatus) are deficient since such approaches undesirably: 1. are not able to produce profiled measurements; 2. require sophisticated refocusing of the laser beam launch system and sensing systems; 3. rely on statistical wavefront measurement correlations; and 4. include any combination of more than one of these-identified deficiencies.

The embodiments disclosed herein advance the art since the described method, apparatus and system do not use refocusing mechanisms. An integrated volume measurement is obtained quickly by measuring the slope induced from optical wavefront perturbations caused by the atmosphere as referenced to a spherical reference source.

Sequential measurements are taken quickly, such as at rates of tens to hundreds of hertz, while the atmosphere is considered to be relatively frozen, based on the Greenwood frequency, as described herein. These measurements are combined in post-processing to create profiled measurements outlining the strengths of the refractive index structure parameter from specific portions of the atmosphere. Thus, the embodiments described herein use novel methodology for profiling atmospheric turbulence by means of dynamic range gating of a beam, such as a Rayleigh beacon, without using a dynamic refocusing of the laser beam launch or sensing system resulting in a profiled measurement of the strength of the refractive index structure parameter.

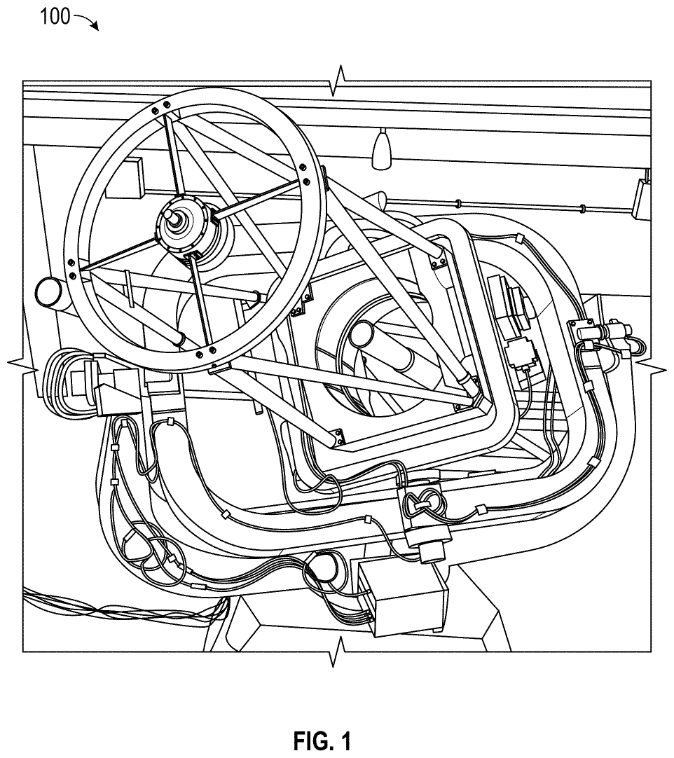

FIG. 1 shows a perspective view of a telescope 100 according to an embodiment described herein. The telescope 100 is described in more detail herein.

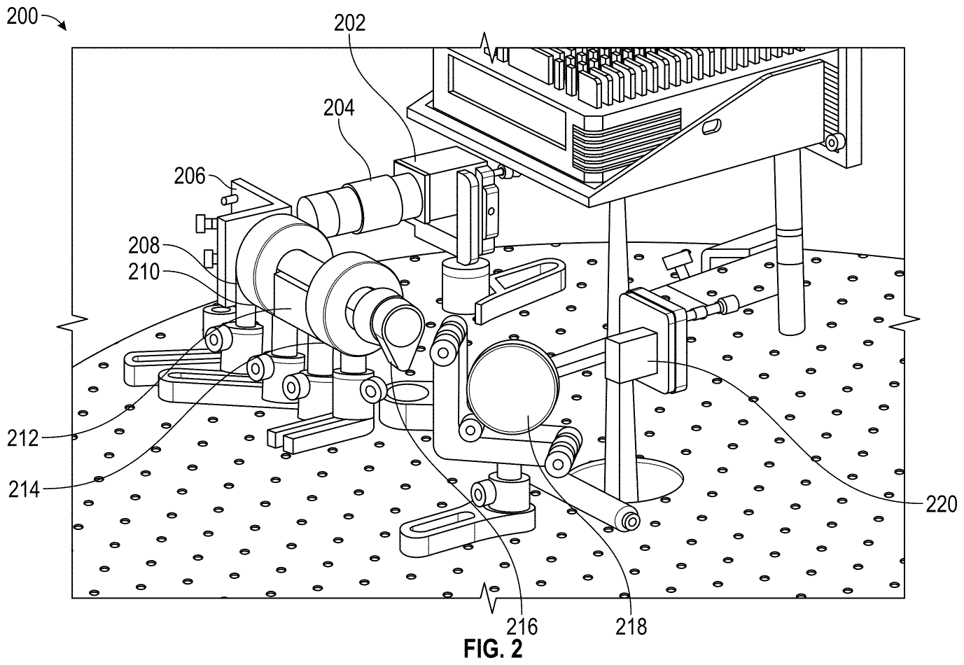

FIG. 2 shows a representation 200 of a modeled layout of components of a sensing system mounted to an optical breadboard on a backside of a telescope.

The modeled layout 200 includes a camera 202, lenslet array 204, turn mirror 206, lens 208, polarizer 210, Pockels cell 212, polarizer 214, lens 216, turn mirror 218 and flip mirror or spectral beam splitter 220.

As shown in FIG. 2, the sensor system 200 is mounted directly on the back of the primary mirror housing since there is no Coude path on the quad axes of the 24-inch telescope (shown in FIG. 1). The sensor system 200 relays the pupil image from the telescope to a Shack-Hartmann wavefront sensor after passing through a Pockels cell 212 that is used as a range gate shutter. This design incorporates turn mirrors 206, 218 to address the unique engineering challenges of fitting everything within the non-interfering volume on the back end of the primary mirror housing.

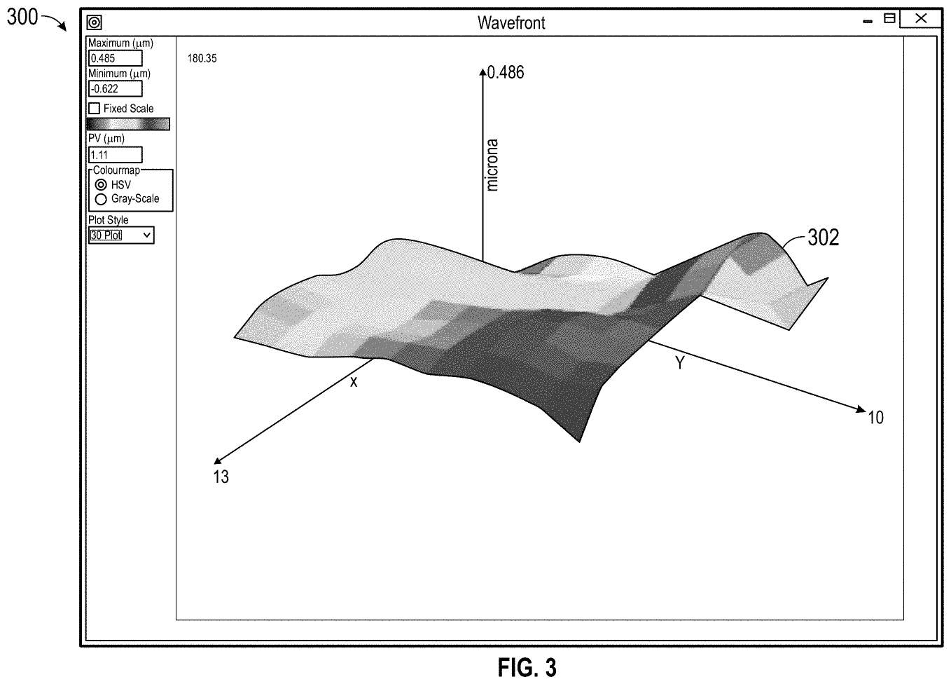

The Rayleigh beacon system is integrated together by a timing control system that can be controlled through scripting or graphical user interfaces. The Rayleigh beacon system is capable of measuring the integrated turbulence induced wavefront error profile as seen across the pupil plane of the telescope. The integrated turbulence induced wavefront error is produced from refractive index fluctuations within a conical volume produced between the Rayleigh beacon at altitude and the telescope system. A Shack-Hartmann wavefront sensor is used to capture this total induced wavefront error. An example of the wavefront captured by the Shack-Hartmann wavefront sensor used in this system is shown in FIG. 3.

The embodiments described herein typically include five subsystems, which comprise: 1) a laser system; 2) a sub-meter class telescope; 3) a laser beam delivery and launch system; 4) a sensor system; and 5) a control and safety system. The laser system allows a sufficient number of photons to propagate multiple kilometers from the transmitting aperture and return to a co-located sensor via any suitable technique, which may typically be molecular (also called Rayleigh) backscatter, while maintaining a small point source like spot as seen from the sensor system.

The laser energy is delivered by the beam delivery and launch system. It is preferred that the beam delivery and launch system is co-aligned on the optical axis of the telescope and remains bore sighted during operation times.

An integrated volume measurement is obtained quickly, at rates of tens to hundreds of hertz, by measuring the slope induced from optical wavefront perturbations caused by the atmosphere as referenced to a spherical reference source.

By maintaining the laser beam propagating substantially along the optical axis of the telescope there is substantially no elongation effects in the image formed on the detection sensor. Systems that have the laser launch system attached to the side of the telescope will by design be fixed at a predetermined distance from the telescope for the backscattered energy returns and cannot be changed without physical movement in the laser launch system alignment and focusing mechanisms. Having the laser launch system aligned to the optical axis of the telescope allows for no moving parts used to maintain alignment at different sensing distances. The sensing system is composed of any suitable sensing system, which may be a Pockels cell system that provides configurable and fast switching delay shuttering of the signal and a Shack-Hartmann wavefront sensor (SHWFS). Using a SHWFS is a suitable method for measuring turbulence from point source references either created by natural stars or artificial laser sources.

One of the many unique embodiments disclosed herein comes from the configurable very precise shuttering control, which controls the distance over which a measurement is taken, coupled with the laser launch system being co-aligned to the optical axis, which allows for no elongation effects when changing reference source distances.

These and other features are designed to maintain the appearance of a point-source reference spot at varied distances as seen by the SHWFS. When operating this system, measurements are taken in quick succession, at rates of tens to hundreds of hertz, all while the atmosphere is considered to be in a frozen flow turbulent state. This allows for post-processing to subtract subsequent measurements from one another along the same frozen turbulent flow path. This process creates the profiled volumetric measurements as dictated by the timing configuration of the Pockels cell shutter.

As will be apparent to those of skill in the art, as described herein, the disclosed method, system and apparatus is to be used in a manner similar to operating a Rayleigh laser beacon. Some significant distinctions are the pre-planning shutter control configuration, which accounts for the region of the atmosphere of interest that will be profiled, and the component design and construction, which account for a major portion of the enabling design choices that allow for rapid movement of the profiled section of the atmosphere.

Profiled segments are influenced by the configured shutter controls, spot size requirements, light budget, and optical alignment of the reference beam. These factors influence the resolution of the profiled measurements, the physical location of the atmosphere that will be measured, and maximum/minimum distances from the sensor that can be measured.

For turbulence characterization and mitigation the regions of interest lie relatively close to the Earth's surface, typically within first few kilometers or over extended slant path ranges. The embodiments described herein are designed to characterize the first region of interest above the earth's surface where there are relatively strong atmospheric turbulence effects.

Alternative applications of the embodiments described herein include uses for horizontal path profiled measurements such as those on a test range or on an aircraft during flight. The embodiments described herein provide an advantage by permitting taking, or acquiring, measurements at variable distances in rapid succession as configured by a user.

One benefit of the disclosed atmospheric profiling system is that it utilizes one side along the propagation path to house a measurement system. Typical conventional systems require a measurement and source device on both sides of the propagation path.

The disclosed system could also be used in real time and in conjunction with an adaptive optics system. Being able to sense and utilize profiled atmospheric turbulence effects in contrast to merely obtaining large integrated volumes of raw data is a rising need for large mirror adaptive optics systems such as those being developed for high resolution imaging and directed energy weapons that may operate in less than ideal environments.

Thus, the described system, method and apparatus involve a novel engineering hardware design for a three-dimensional atmospheric turbulence profiler that uses design choices to reduce the hardware components while allowing for rapid atmospheric turbulence measurements. This novel approach is accomplished by using a reference laser aligned to the optical axis that is optimized to produce a relatively small point source like spot to the turbulence sensor at any chosen distance away from the source. This is accomplished without the need for refocusing of the outgoing beam or refocusing of the sensor system.

Additionally, the laser chosen has a repetition rate fast enough to sample the atmosphere many times while the atmosphere is considered frozen in terms of turbulent flow. By use of a precisely timed shutter with dynamic controls, different parts of the atmosphere can be sampled on a pulse by pulse basis.

As described herein, this novel approach utilizes backscatter of laser energy from gas molecules and aerosol particles in the atmosphere and a precision timing delay shutter to profile the atmospheric turbulence in the atmosphere. The atmospheric turbulence is measured by a sensor, such as a Shack-Hartmann wavefront sensor, but any suitable wavefront sensor could be used.

The profiled measurements are made quickly while the atmosphere is considered frozen in terms of turbulence on a pulse by pulse basis from the pulsed laser source. The timing on each laser pulse return is controlled by the precision shutter control system and can be individually tuned to a desired distance for the turbulence measurement. Taking multiple individual measurements in succession and then processing them together creates a profiled measurement. The result is a profile of turbulence strength along the optical path being viewed.

The laser beam that was used was manufactured by Photonics Industries International, Inc., model: DP-527-8 (DP-L series)

FIG. 3 shows a representation 300 of an example waveform measured by a wavefront sensor. Specifically, the wavefront measured in FIG. 3, is measured by the Shack-Hartmann wave sensor, as described herein, particularly in relation to FIG. 2 above.

One embodiment includes the timing and control system that produces the range gate for the Rayleigh beacon coupled with a laser beam launch system that is centered on the optical axis. The laser beam launch system is configured to produce a collimated beam at a desired beam waist size such that the range gate for collecting the backscattered light can be changed to be shorter or longer in time without the need to physically move the Shack-Hartmann wavefront sensor back and forth into a perfect focus point. This allows the Rayleigh beacon control system to use preprogrammed timing changes on the range gate at specific intervals on a per pulse basis. The laser used is capable of producing strong enough pulses to receive return energy up to 200 Hz. This means that the system is capable of making up to 200 individual measurements per second from different range gated time intervals resulting in integrated volumes along the optical path at prechosen lengths.

It is useful to account for the expected rate at which the wavefront phase structure changes due to the refractive index fluctuations in the atmosphere. This is known as the atmospheric time constant, τ₀. Related to this is the Greenwood frequency, f_{G}, which is a characteristic frequency of the atmospheric turbulence. Typical values for the Greenwood frequency under nominal atmospheric conditions are 10's of hertz. The Greenwood frequency is related the atmospheric time constant by the equation:

f_{G}=0.1338/τ₀

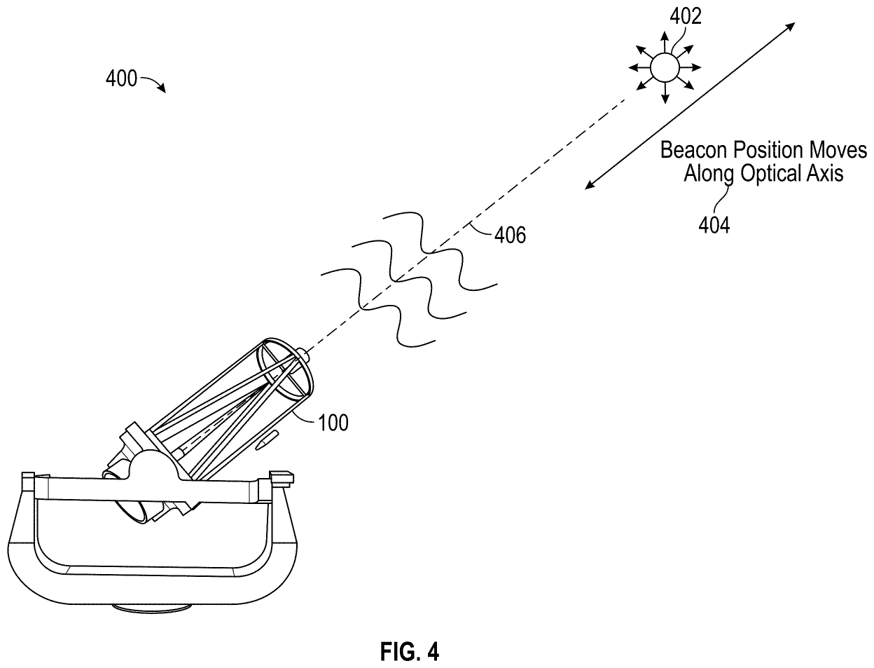

The Greenwood frequency is important as it is the rate at which the atmosphere can be considered to be frozen from a changing turbulence induced wavefront error perspective. For the measurement scheme used with this Rayleigh beacon system, the Greenwood frequency defines how many measurements can be taken before the atmosphere changes. For example, if the Greenwood frequency during a collection window is approximately 20 Hz and the laser system is programmed to run at 200 Hz, that means it is possible to make about ten individual measurements before the atmosphere changes, from a relatively frozen state. This is important because in this example these ten measurements will be used with preprogrammed range gate delay; changes that are sequentially shorter in time resulting in integrated volume turbulence measurements that can be used to profile the atmospheric path. These measurements can then be subtracted from each other sequentially to produce profile measurements of the turbulence effect on the wavefront along the optical axis. The Rayleigh beacon operation is depicted in FIG. 4.

In order to optimize the design of the Rayleigh guidestar system it is optimal to account for the spot size of the beacon and the radiometry of the scenario. The optimization parameter of the pixel variance is minimized and accounts for both the geometry and radiometry.

FIG. 4 shows a representation 400 of a beacon showing initial, or notional, measurement configuration. Telescope 100 produces beam 406 to target 402. The beacon position moves along an optical axis as shown by 404.

It is important to be able to take multiple measurements of the integrated turbulence induced wavefront error at different ranges faster than the atmosphere changes (as discussed in relation to the frozen state delineated by the Greenwood frequency) because it allows for the creation of vertically layered atmospheric turbulence profile measurement regions. When comparing to known models for the refractive index structure parameter, this type of measurement can more accurately show the varied effects by turbulent layers within the atmosphere rather than a measurement of an integrated parameter like the Fried parameter.

From a single measurement, the Rayleigh beacon can produce a measurement of the Fried parameter for the entire integrated volume. The Fried parameter is defined as:

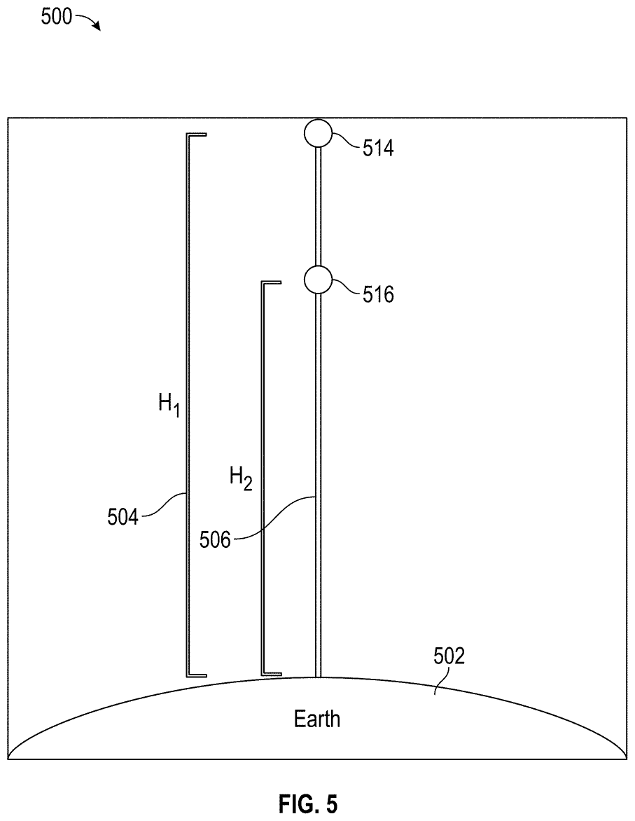

r₀=[0.423k² sec ζ∫₀^{H}Cₙ²(h)dh]^{-3/5}

where k is the wave number, ζ is the zenith angle, H is the altitude, and Cₙ² is the refractive index structure parameter. Then taking Fried parameter measurements as depicted in FIG. 5, subtraction can be performed to solve for the refractive index structure parameter for a region in the atmosphere.

$${C}_{n}^{2} ( h ) {\vert}_{{H}_{2}}^{{H}_{1}} = \frac{{( {r}_{0 , 1} - {r}_{0 , 2} )}^{- 5 / 3}}{0.423 {k}^{2} sec ζ}$$

Known turbulence models may be used as a comparison to measurements from the Rayleigh beacon system. Example models that may be used are the Hufnagel-Valley model, an atmospheric parameter derived model, or a new time-lapse imagery derived estimation technique.

The new time-lapse imagery derived estimation technique relies on measurements taken on subsequent frames from an imaging camera. In these images, local and total image shifts will occur caused by atmospheric turbulence. These shifts can be measured and fit to statistics that enable estimation of various atmospheric parameters along the imaging path such as the Fried parameter, r₀.

The Hufnagel-Valley model is described by the equation

Cₙ²(h)=8.2×10⁻²⁶W²h¹⁰e^{-h}+2.7×10⁻¹⁶e^{-h/1.5}+Ae^{-h/0.1}

where h is the altitude in kilometers and W is the root mean squared wind speed. It is important to recognize that this is the Hufnagel model with an additional term for the ground layer. The atmospheric parameter derived model is described by the equation

$${C}_{n}^{2} ( h ) = 2.8 \frac{{K}_{H}}{{K}_{M}} {( 79 \times 1 {0}^{- 6} \frac{P}{{T}^{2}} )}^{2} {{L}_{0}^{3 / 4} ( \frac{\partial T}{\partial z} + {γ}_{d} )}^{2} \qquad ( 5 )$$

where L₀ is the outer scale length of the atmospheric turbulence, K_{H} is the eddy diffusivity for heat, and K_{M} is the eddy diffusivity for momentum, γ_{d} is the adiabatic lapse rate.

FIG. 5 shows a representation 500 of measurement regions for altitudes ranging from the ground to heights H₁ and H₂.

As shown in FIG. 5, a first measurement region at height H₁ 504 is at terminus 514 from the surface of earth 502. A second height H₂ 506 is at terminus 516 from the surface of earth 502. The measurement regions for altitudes ranging from the ground to heights of H₁ 504 and H₂ 506 are shown.

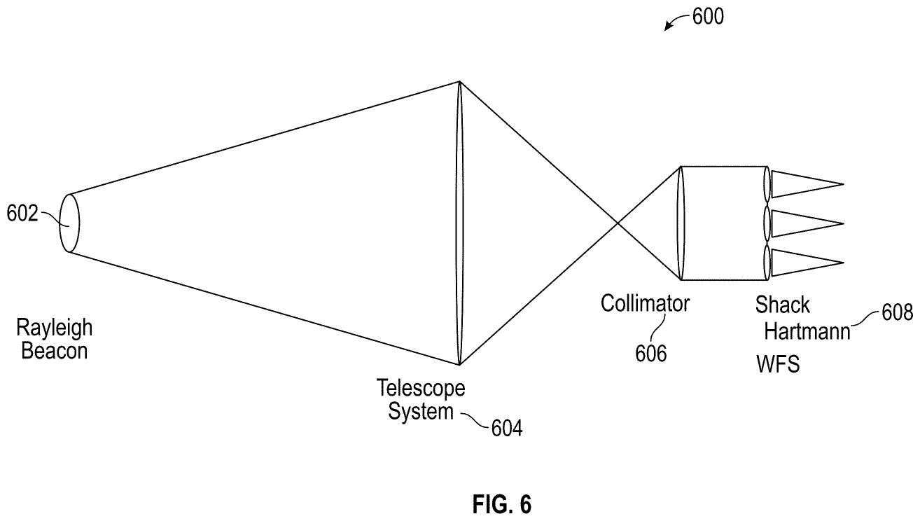

FIG. 6 shows a representation of a system 600 according to an embodiment described herein. System 600 includes a Rayleigh beacon 602, telescope system 604, collimator 606, Shack-Hartmann WFS 608.

One technique to obtain the angular spot, is to calculate the tangent of the spot size radius over the distance from the beacon to the detector sub-aperture projected onto the primary mirror.

An equation of wavefront sensor pixel variance:

σ=Shack Hartmann Wavefront sensor pixel variance

$$\begin{matrix}{σ}_{ϕ} = {\frac{{π}^{2} {K}_{g}}{4 \times SNR} [ {( \frac{3}{2} )}^{2} + {( \frac{θ d}{λ} )}^{2} ]}^{\frac{3}{2}} & {r}_{0} > d \\ {σ}_{ϕ} = {\frac{{π}^{2} {K}_{g}}{4 \times SNR} [ {( \frac{3 d}{2 {r}_{0}} )}^{2} + {( \frac{θ d}{λ} )}^{2} ]}^{\frac{1}{2}} & {r}_{0} < d\end{matrix}$$

SNR=signal to noise ratio

$$SNR = \frac{N}{{[ N + {n}_{pix} ( {σ}_{r}^{2} + {σ}_{bg}^{2} ) ]}^{1 / 2}}$$

N=number of signal electrons

nₚᵢₓ=number of pixels per sub-aperture

σᵣ=number of noise electrons per pixel

σ_{bg}=number of background electrons per pixel d=sub-aperture dimension

θ=angular diameter of source

K_{g}=scale factor; increase in error at a null due to spot displacement on sensor

To determine the spot size at a distance z:

$${ω}_{r} ( z ) = {ω}_{0} \sqrt{1 + {( \frac{{M}^{2} λ z}{{πω}_{0}^{2}} )}^{2}}$$

ω_{R}(z)=spot size at distance z

ω₀=minimum spot size

M²=beam quality

λ=wavelength

z=distance to spot

π=Pi, 3.14159

The number of photo-detected electrons per sub-aperture:

$${N}_{PDE} = η {T}_{t} {T}_{r} {T}_{at m}^{2} \frac{{A}_{sub} {β}_{BS} Δ l}{{R}^{2}} \frac{{E}_{p} λ}{hc}$$

N_{PDE}=number of photo-detected electrons per sub-aperture

η=quantum efficiency

T=transmit, receive, or atmospheric transmission

A_{sub}=area of wavefront sensor sub-aperture

β_{BS}=incident fraction of backscattered laser photons per meter

Δl=length of the scattered volume

R=range to beacon center

Eₚ=energy per pulse from laser

λ=wavelength

h=Plank's constant (6.62606957×10⁻³⁴ m² kg/s)

c=speed of light (299792458 m/s)

For example, optimization parameter (pixel variance) value is approximately 1.0. The optimized launch radius value is approximately 5.8 cm.

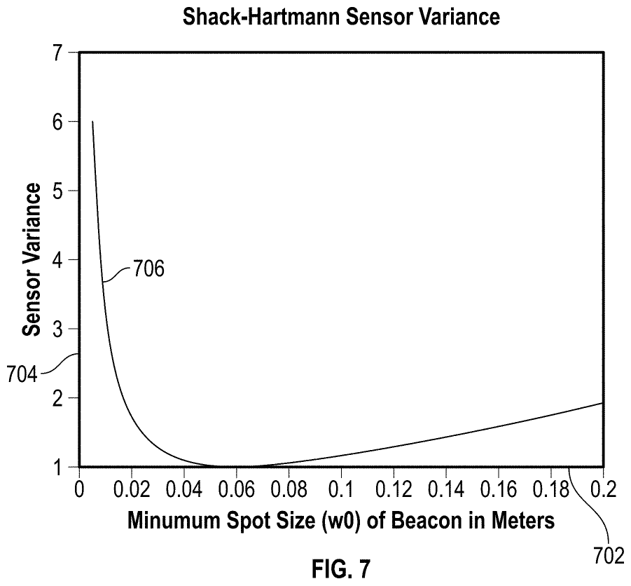

FIG. 7 shows a graphical representation 700 of sensor variance according to an embodiment described herein. FIG. 7 shows an example of the relationship between Shack-Hartmann sensor variance and minimum spot size of a beacon. Specifically, the minimum spot size (w₀) of beacon, in meters, is plotted on x-axis 702. Sensor variance is plotted on y-axis 704. Line 706 shows the relationship between these two parameters.

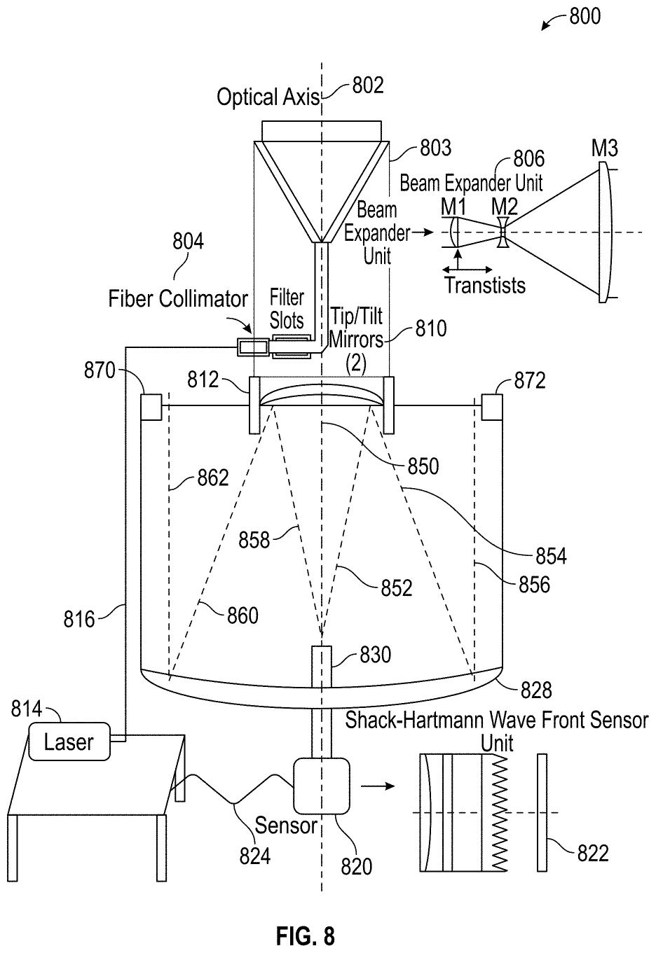

FIG. 8 shows a representation of a model layout of a system 800 according to an embodiment described herein. FIG. 8 shows a laser launch device 803 that includes optical axis 802, fiber collimator 804, beam expander unit 806, tip tilt mirrors 810 and filter slots 812. The laser launch unit 803 produces output laser 850 based on laser input from laser source 814 and connection 816 to fiber collimator 804. The output laser 850 that is received by receptacle 828, which includes column 830 and sensor 820. The sensor 820 includes a wavefront sensor 822, which may be a Shack-Hartmann wavefront sensor. The output laser 850 reflects from surface 828 to produce laser portions 852, 854, 856, 858, 860 and 862. Portions 870 and 872 show a boundary region for the reflected laser beam portions.

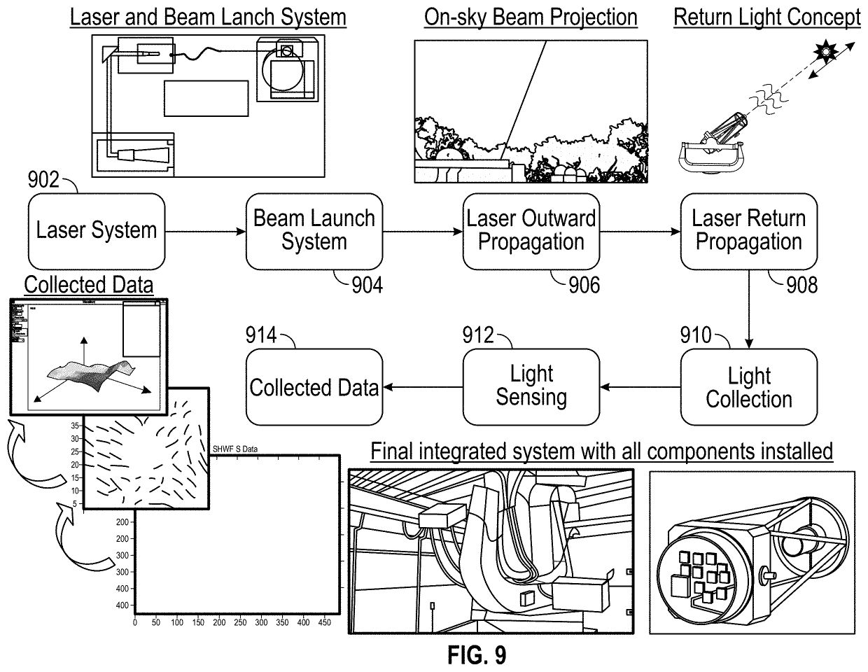

FIG. 9 shows a flowchart 900 according to an embodiment described herein. As shown in FIG. 9, the laser system 902 provides a laser to beam launch system 904. Laser outward propagation is shown in 906 and laser return propagation is shown 908. The laser outward propagation 906 propagates a laser to a sensor and the return 908 provides a back-propagating beam. Light collection 910 and light sensing 912 are also shown. Data from the sensed light is collected as shown 914.

It is a further embodiment of the present disclosure that, as discovered, the curvature of the wavefront entering the sensing system drastically effects how the sensing system performs, particularly the blocking ability of the system's shutter. As the beacon height is changed from far from the collecting telescope (approximately >5 km) to close ranges (approximately <1.5 km) the curvature of the wavefront becomes more pronounced. This is manifested because there is a change in the image position. It was initially thought that the change of the image positions would not affect measurements as the system is designed to extract data from the pupil plane image (which is a relay of the entrance aperture, and not at focus of the telescope system). However, the increased curvature of the optical field degraded the performance of some of the sub-components in the system resulting in the loss of ability to produced measureable data. This issue is mitigated by design of a polarization rectifier. This polarization rectifier will flatten the curvature and allow for extended performance over the ranges of interest for the sensing system.

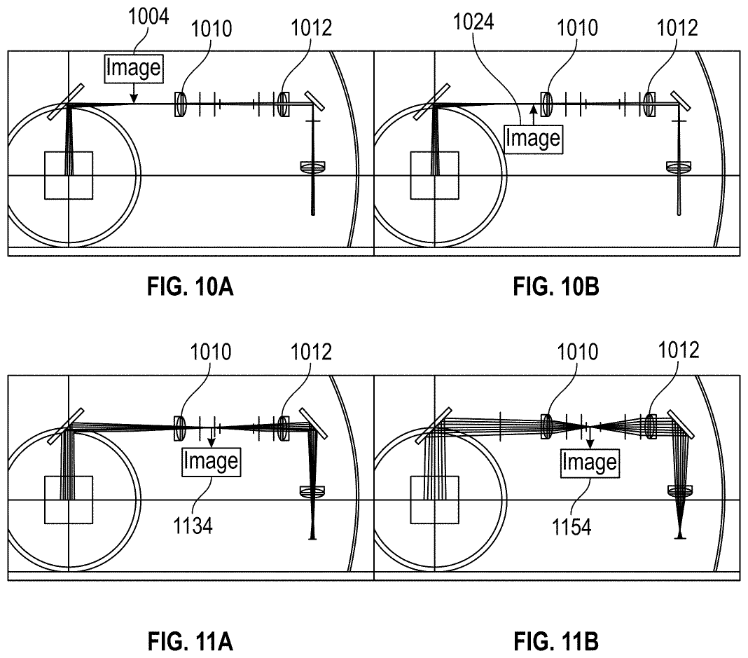

FIGS. 10A and 10B show representations of a model of a sensing system for beacon ranges of infinity and 5 km, respectively. FIG. 10A shows image position 1004 and FIG. 10B shows image position 1024. Relay lenses 1010 and 1012 are shown in FIGS. 10A and 10B and FIGS. 11A and 11B. The illustration of FIGS. 10 and 11 is to show how the beacon ranges and the position of the image and position of the relay lens interrelate to one another. The other components of the sensing system have been described herein.

FIGS. 11A and 11B show representations of a model of a sensing system for beacon ranges of 1 km and 0.4 km, respectively. FIG. 11A shows image position 1134 and FIG. 11B shows image position 1154. The other components of the sensing system have been described herein.

Specifically, FIGS. 10A and 10B and FIGS. 11A and 11B show a series of Zemax models, illustrating the effect of lowering the altitude of the beacon and how the image position (1004, 1024, 1134 and 1154) is moved. Issues involving curvature arise when the image position (1004, 1024, 1134 and 1154) is located between the two relay lenses (1010, 1012). This is shown for ranges of 1 km and lower, as shown in FIGS. 11A and 11B, which show 1 km and 0.4 km, respectively.

It was discovered through on-sky testing that the curvature of the wavefront entering the sensing system drastically effects how the sensing system performs, particularly the blocking ability of the system's shutter. As the beacon height is changed from far from the collecting telescope (>5 km) (FIGS. 10A and 10B) to close ranges (<1.5 km) FIGS. 11A and 11B, the curvature of the wavefront becomes more pronounced. This is manifested because of a change in the image position. It was initially believed that the change of the image position would not affect measurements since the system is designed to extract data from the pupil plane image (which is a relay of the entrance aperture, and not at focus of the telescope system). However, the increased curvature of the optical field degraded the performance of some of the sub-components in the system resulting in the loss of ability to produce measurable data. This issue is mitigated by design of a polarization rectifier. This polarization rectifier is designed to flatten the curvature and allow for extended performance over the ranges of interest for the sensing system.

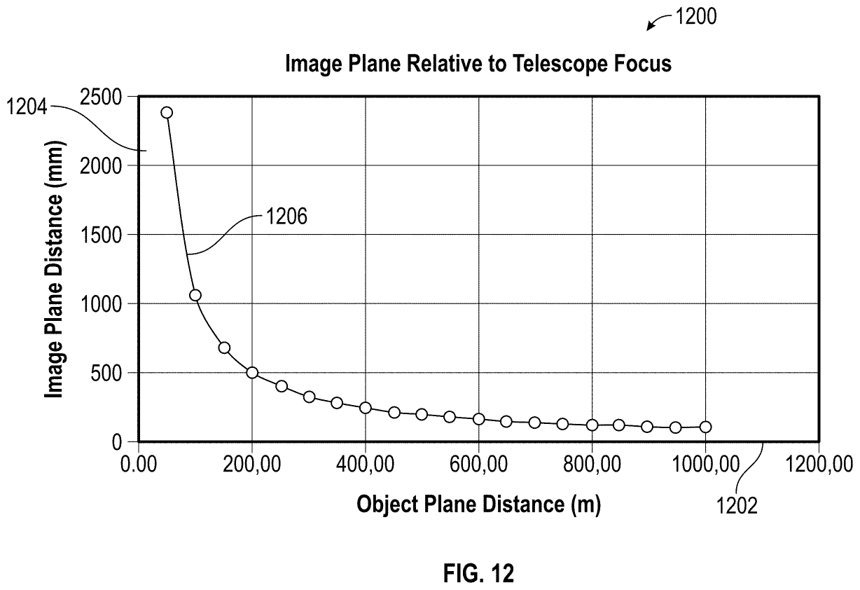

FIG. 12 shows a representation 1200 of the movement modeled results for low altitude beacons by plotting object plane distance, in meters, on x-axis 1202, image plane distance, in millimeters, on y-axis 1204 and plot line 1206.

As shown in FIG. 12, plot line 1206 shows that at relatively extremely low altitudes the beacon position drastically affects the system. The system represented by plot line 1206 was optimized for data collections operating from ranges of approximately 500 m and greater. FIG. 12 shows a strong effect at approximately 300 meters object plane distances and lower. This will have a limiting effect on the system, by preventing operation at this range (closeness) to the telescope. However, these effects can be mitigated with a polarization rectifier, which is described herein.

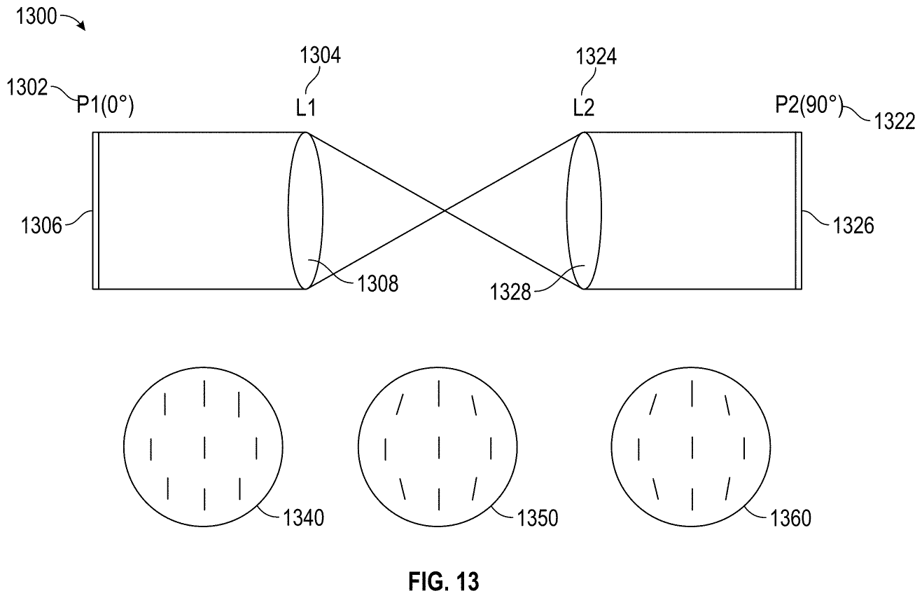

FIG. 13 shows a representation 1300 of a curvature experienced between two polarizers. FIG. 13 shows polarizer P1(0°) 1302 and polarizer P2 (90°) 1322. A graphical representation of curvatures is shown as 1340, 1350 and 1360.

As shown in FIG. 13, the curvature experienced between two polarizing elements, P1 1302 and P2 1322 due to a lens system is depicted. This same effect is magnified by a change in beacon location which imposes a change in the image location as depicted in the Zemax models, shown in FIGS. 10A and 10B and FIGS. 11A and 11B. The light rays shown in FIGS. 11A and 11B, between the two relay lenses (1010, 1012) have a relatively large converging effect that creates curvature in the field.

In the turbulence profiling system in this location between the two polarizers (P1 1302 and P2 1322) there is a Pockels cell element. The Pockels cell acts as the shutter of the system which operates on the principle of polarization. The Pockels cell will rotate the polarization state by 90 degrees as controlled through the overall systems control module. This rotation will allow light to pass or be blocked as the orientation of the Pockels cell is matched to the two crossed polarizers P1 1302 and P2 1322. The timing of this shutter is the part of sensing system that allows for dynamic ranging.

When the optical field has relatively large amounts of curvature in it from relatively low altitude beacons, the Pockels cell is unable to effectively rotate the total field to match the orientation of P2 1322. This means less light passes through the system and the total signal-to-noise ratio (SNR) is degraded. Additionally, the curvature also imposed on P2 1322 in the blocking state decreases the polarizer's ability to block light. Allowing light to pass during the blocking state adds relatively large amounts of background noise that may saturate the sensitive camera of the sensing system, effectively resulting in a loss of data collected. One approach to mitigate this is to add a polarization rectifier to the system before light reaches the Pockels cell.

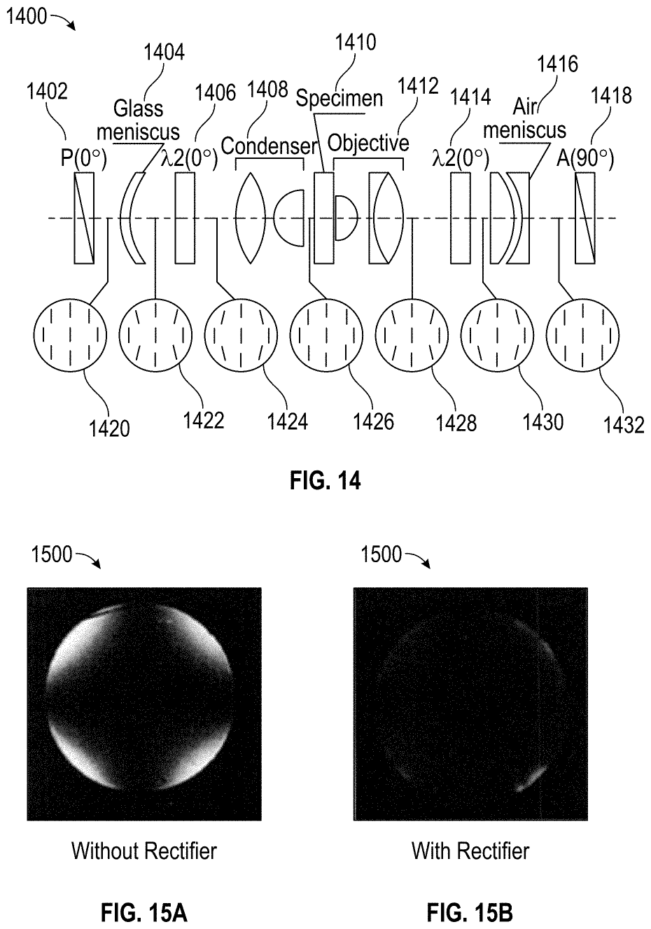

A depiction of a polarization rectified, and the resulting effect is shown in FIGS. 14, 15A and 15B. This will allow the turbulence profiling system to operate through sensing scenarios that experience relatively large amounts of optical field curvature.

FIG. 14 shows a representation 1400 of a polarization rectifier according to an embodiment described herein.

As shown in FIG. 14, representation 1400 includes elements of a polarization rectifier and the resulting field curvature effects. The elements include P(0°) 1402, field curvature effects representation 1420, glass meniscus 1404, field curvature effects representation 1422, λ/2 (0°) 1406, field curvature effects representation 1424, condenser 1408, field curvature effects representation 1426, specimen 1410, objective 1412, field curvature effects representation 1428, λ/2 (0°) 1414, field curvature effects representation 1430, air meniscus 1416, field curvature effects representation 1432 and, A(90°) 1418.

FIGS. 15A and 15B shows a representation of optical field curvature experience with rectifier and without a polarization rectifier, respectively.

This optical field curvature, as described herein, is only a limitation of the system if the system is built without a polarization rectifier FIG. 15A. The system could still dynamically range and produce measured profiles of atmospheric turbulence, but only for extended ranges greater than approximately 1.5 km. It has been noted that as the collecting aperture of the system grows in diameter this effect becomes more pronounced and the limitations in range imposed will be more severe.

Various embodiments of the present disclosure are described herein and include examples of the present disclosure. The embodiments described above and summarized below are combinable.

One embodiment is directed to an apparatus to profile atmospheric turbulence, comprising: a telescope having a telescope optical axis; a laser configured to generate a plurality of pulses at a pulse repetition rate; a laser beam mechanism, coupled to the laser, having a laser optical axis configured to be substantially coincident with the telescope optical axis, such that the plurality of pulses forms a collimated laser beam propagating along the telescope optical axis; at least one shutter coupled to the telescope; one or more wavefront sensors, coupled to the shutter, the shutter being a range gate for the wavefront sensor; and a controller coupled to the laser and the shutter, the controller configured to coordinate operation of the shutter with a pulse of the plurality of pulses.

Another embodiment is directed to the apparatus described, where the shutter further comprises a Pockels cell.

Yet another embodiment is directed to the apparatus described, where at least one of the one or more sensors is a wavefront sensor configured to measure curvature of light waves.

Yet another embodiment is directed to the apparatus described, where the laser beam mechanism is configured to utilize a dynamic range beacon.

Yet another embodiment is directed to the apparatus described, where the controller is configured to determine a slope induced from sensed optical wavefront perturbations caused by atmospheric conditions as referenced to a spherical reference source.

Yet another embodiment is directed to the apparatus described, where the wavefront sensor further comprises a Shack-Hartmann wavefront sensor.

Yet another embodiment is directed to the apparatus described, where the wavefront sensor further comprises at least one of a pyramid wavefront sensor, a curvature wavefront sensor, and an interferometer.

Yet another embodiment is directed to the apparatus described, where the telescope further comprises a Cassegrain telescope.

Yet another embodiment is directed to the apparatus described, where the telescope further comprises a Ritchey-Chrétien telescope.

Yet another embodiment is directed to the apparatus described, where the pulse repetition rate is between approximately 20 and 2000 pulses per second.

Yet another embodiment is directed to the apparatus described, where the pulse repetition rate is approximately 200 pulses per second.

Yet another embodiment is directed to the apparatus described, where the controller is configured to map a curvature on a pulse-by-pulse basis.

Yet another embodiment is directed to the apparatus described, where the controller is configured to map a curvature of light waves to measure a wavefront.

Yet another embodiment is directed to the apparatus described, where the controller is configured to map a curvature based at least in part on differential image motion.

Yet another embodiment is directed to the apparatus described, where the pulse repetition rate exceeds a Greenwood frequency.

Yet another embodiment is directed to the apparatus described, where a timing of the shutter determines a range of the range gate for the wavefront sensor.

Yet another embodiment is directed to the apparatus described, where the controller is further configured to change the timing of the shutter between successive laser pulses.

Yet another embodiment is directed to a method to generate an atmospheric turbulence profile, comprising: providing a telescope, having a telescope optical axis; generating a plurality of laser pulses at a pulse repetition rate; forming a collimated laser beam from the plurality of laser pulses, the collimated laser beam having a laser optical axis substantially coincident with a telescope optical axis, such that the collimated laser beam propagates along the telescope optical axis; coupling a shutter and a wavefront sensor to the telescope, the shutter acting as a range gate for the wavefront sensor; and coordinating operation of the shutter and the wavefront sensor with a timing of a laser pulse.

Yet another embodiment is directed to the method, where the shutter further comprises a Pockels cell.

Yet another embodiment is directed to the method where the wavefront sensor further comprises a Shack-Hartmann wavefront sensor.

Yet another embodiment is directed to the method, where the wavefront sensor further comprises at least one of a pyramid wavefront sensor, a curvature wavefront sensor, and an interferometer.

Yet another embodiment is directed to the method, where the telescope further comprises a Cassegrain telescope.

Yet another embodiment is directed to the method, where the telescope further comprises a Ritchey-Chrétien telescope.

Yet another embodiment is directed to the method, where the pulse repetition rate is between approximately 20 and 2000 pulses per second.

Yet another embodiment is directed to the method, where the pulse repetition rate exceeds a Greenwood frequency.

Yet another embodiment is directed to the method, further comprising determining a range of the range gate for the wavefront sensor.

Yet another embodiment is directed to the method, further comprising changing the timing of the shutter between successive laser pulses.

Yet another embodiment is directed to the method, further comprising mapping a curvature of light waves to measure a wavefront.

Yet another embodiment is directed to the method, further comprising generating configurable profiled measurements of existing atmospheric turbulence.

Those of ordinary skill in the art realize that the following descriptions of the embodiments of the present disclosure are illustrative and are not intended to be limiting in any way. Other embodiments will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the disclosure. Accordingly, the following embodiments are set forth without any loss of generality to, and without imposing limitations upon, the claims.

In this detailed description, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present disclosure.

Furthermore, in this detailed description, a person skilled in the art should note that quantitative qualifying terms such as “generally,” “substantially,” “mostly,” “approximately” and other terms are used, in general, to mean that the referred to object, characteristic, or quality constitutes a majority of the subject of the reference. The meaning of any of these terms is dependent upon the context within which it is used, and the meaning may be expressly modified.

Some of the illustrative embodiments of the present disclosure may be advantageous in solving the problems herein described and other problems not discussed which are discoverable by a skilled practitioner. While the above description contains much specificity, these should not be construed as limitations on the scope of any embodiment, but as exemplifications of the presented embodiments thereof. Many other ramifications and variations are possible within the teachings of the various embodiments. While the disclosure has been described with reference to exemplary embodiments, it will be understood by those skilled in the art that various changes may be made and equivalents may be substituted for elements thereof without departing from the scope. In addition, many modifications may be made to adapt a particular situation or material to the teachings without departing from the essential scope thereof.

Therefore, it is intended that the disclosure not be limited to the particular embodiment disclosed as the best or only mode contemplated for carrying out this disclosure, but that the disclosure will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation, the scope of the disclosure therefore not being so limited. Moreover, the use of the terms first, second, etc. do not denote any order or importance, but rather the terms first, second, etc. are used to distinguish one element from another.

Furthermore, the use of the terms a, an, etc. do not denote a limitation of quantity, but rather denote the presence of at least one of the referenced item. Thus, the scope of the disclosure should be determined by the appended claims and their legal equivalents, and not by the examples given.

1. An apparatus to profile atmospheric turbulence, comprising:
a telescope having a telescope optical axis;
a laser configured to generate a plurality of pulses at a pulse repetition rate;
a laser beam mechanism, coupled to the laser, having a laser optical axis configured to be substantially coincident with the telescope optical axis, such that the plurality of pulses forms a collimated laser beam propagating along the telescope optical axis;
at least one shutter coupled to the telescope;
one or more wavefront sensors, coupled to the shutter,
the shutter being a range gate for the wavefront sensor; and
a controller coupled to the laser and the shutter the controller configured to coordinate operation of the shutter with a pulse of the plurality of pulses.

2. The apparatus of claim 1, where the shutter further comprises a Pockels cell.

3. The apparatus of claim 1, where at least one of the one or more sensors is a wavefront sensor configured to measure curvature of light waves.

4. The apparatus of claim 1, where the laser beam mechanism is configured to utilize a dynamic range beacon.

5. The apparatus of claim 1, where the controller is configured to determine a slope induced from sensed optical wavefront perturbations caused by atmospheric conditions as referenced to a spherical reference source.

6. The apparatus of claim 1, where the wavefront sensor further comprises a Shack-Hartmann wavefront sensor.

7. The apparatus of claim 1, where the wavefront sensor further comprises at least one of a pyramid wavefront sensor, a curvature wavefront sensor, and an interferometer.

8. The apparatus of claim 1, where the telescope further comprises a Cassegrain telescope.

9. The apparatus of claim 1, where the telescope further comprises a Ritchey-Chrétien telescope.

10. The apparatus of claim 1, where the pulse repetition rate is between approximately 20 and 2000 pulses per second.

11. The apparatus of claim 1, where the pulse repetition rate is approximately 200 pulses per second.

12. The apparatus of claim 1, where the controller is configured to map a curvature on a pulse-by-pulse basis.

13. The apparatus of claim 1, where the controller is configured to map a curvature of light waves to measure a wavefront.

14. The apparatus of claim 1, where the controller is configured to map a curvature based at least in part on differential image motion.

15. The apparatus of claim 1, where the pulse repetition rate exceeds a Greenwood frequency.

16. The apparatus of claim 1, where a timing of the shutter determines a range of the range gate for the wavefront sensor.

17. The apparatus of claim 16, where the controller is further configured to change the timing of the shutter between successive laser pulses.

18. A method to generate an atmospheric turbulence profile, comprising:
providing a telescope, having a telescope optical axis;
generating a plurality of laser pulses at a pulse repetition rate;
forming a collimated laser beam from the plurality of laser pulses, the collimated laser beam having a laser optical axis substantially coincident with a telescope optical axis, such that the collimated laser beam propagates along the telescope optical axis;
coupling a shutter and a wavefront sensor to the telescope, the shutter acting as a range gate for the wavefront sensor; and
coordinating operation of the shutter and the wavefront sensor with a timing of a laser pulse.

19. The method of claim 18, where the shutter further comprises a Pockels cell.

20. The method of claim 18, where the wavefront sensor further comprises a Shack-Hartmann wavefront sensor.

21. The method of claim 18, where the wavefront sensor further comprises at least one of a pyramid wavefront sensor, a curvature wavefront sensor, and an interferometer.

22. The method of claim 18, where the telescope further comprises a Cassegrain telescope.

23. The method of claim 18, where the telescope further comprises a Ritchey-Chrétien telescope.

24. The method of claim 18, where the pulse repetition rate is between approximately 20 and 2000 pulses per second.

25. The method of claim 18, where the pulse repetition rate exceeds a Greenwood frequency.

26. The method of claim 18, further comprising determining a range of the range gate for the wavefront sensor.

27. The method of claim 18, further comprising changing the timing of the shutter between successive laser pulses.

28. The method of claim 18, further comprising mapping a curvature of light waves to measure a wavefront.

29. The method of claim 18, further comprising generating configurable profiled measurements of existing atmospheric turbulence.
